(19) United States
(12) Patent Application Publication
(10) Pub. No.: US 2024/0391814 A1
(43) Pub. Date: Nov. 28, 2024

(54) INCLUDING SMALL AESTHETIC BUBBLES IN GLASS ARTICLES

(71) Applicant: Owens-Brockway Glass Container Inc., Perrysburg, OH (US)

(72) Inventors: Dan Swiler, Maumee, OH (US); Amanda Godsil, Rutherford, NJ (US); Scott Cooper, Perrysburg, OH (US); Jose Garay Castillo, Apodaca N.L. (MX); Enrique Gonzales, Zapopan Jal. (MX)

(21) Appl. No.: 18/693,511

(22) PCT Filed: Oct. 5, 2022
(86) PCT No.: PCT/US2022/045779

§ 371 Date: Mar. 19, 2024

Related U.S. Application Data
(60) Provisional application No. 63/254,023, filed on Oct. 8, 2021.

(51) Int. Cl. C03B 5/173; C03B 5/16

(52) U.S. Cl. CPC C03B 5/173; C03B 5/16

(57) ABSTRACT

A method of forming glass articles involves introducing a particulate mixture (20) of SiC particles and carrier particles into molten glass (44, 22) contained within at least one of a forehearth (12) or a fining chamber (28) of a glass-making furnace (10). The particulate mixture (20) creates seeds (S) within the molten glass such that an outflow of conditioned molten glass (18) discharged from the forehearth (12) and the glass articles produced therefrom contain a greater concentration of seeds (S) than if the particulate mixture (20) is not added. The concentration of seeds (S) in the glass articles can be controlled by commencing or withholding the addition of the particulate mixture (20).

The present disclosure is directed to glass manufacturing and, more specifically, to methods for making glass articles with varying concentrations of small bubbles, commonly called seeds, within the glass.

### BACKGROUND

Oxide glasses are rigid amorphous solids that lack long range order and have strong bonding between two coordinated oxygen and the metal or semimetal atoms present in the glass. This bonding provides a network that is both strong and allows for a variety of structural configurations. The term “vitreous” is often used to describe the amorphous, non-crystalline state of glass. Traditionally, glass is produced in a continuous melting furnace that includes a melting chamber, a fining chamber, and at least one forehearth. In the melting chamber, a vitrifiable feed material (also commonly referred to as a glass batch material) is fed on top of a bath of molten glass through a batch feeder. This material is typically heated by the combustion of a mixture of fuel and oxidant in the space above the glass bath. The combustion flames radiantly heat the molten glass bath so that the vitrifiable feed material can melt, flow, and mix into the bath assisted by convective currents. The molten glass bath becomes more homogenized as the glass flows towards a throat that separates the melting and fining chambers. The throat allows glass to flow from the glass bath in the melting chamber to a molten glass fining bath in the fining chamber.

Certain components of the vitrifiable feed material—most notably, raw materials such as carbonates, sulfides, oxides, sulfates, and sulfides—may introduce gas bubbles into the molten glass bath upon melting, reacting, or decomposing within the molten glass bath in the melting chamber. In addition, air trapped between vitrifiable feed material particles may also introduce gas bubbles of various sizes into the glass bath. In some industries, the entrained gas bubbles are removed from the molten glass—a process known as “fining”—in the melting chamber and in the fining chamber to the extent needed to satisfy commercial production specifications. The glass is fined so that articles formed from the glass, especially if those articles are glass containers, are aesthetically appealing and exhibit a consistent appearance.

The removal of gas bubbles begins in the high temperature melting chamber as the larger gas bubbles quickly ascend through the molten glass bath and burst when they reach the surface of the glass bath. This process may be assisted by fining agents, which are secondary materials (e.g., sodium sulfate) included in the vitrifiable feed material that become less soluble in glass as the temperature of the glass increases. The gasses released by these fining agents combine with and enlarge existing gas bubbles, thereby increasing the rate at which the enlarged bubbles rise to the top of the molten glass. The concentration of entrained gas bubbles in the molten glass fining bath is additionally reduced within the fining chamber on the other side of the throat. In the fining chamber, entrained gas bubbles continue to rise out of the molten glass fining bath, which is aided by achieving a non-turbulent flow of the bath to promote the timely ascension and escape of the entrained gas bubbles. The molten glass fining bath is also slowly cooled within the fining chamber as the glass flows towards the forehearth. This cooling increases the solubility of certain gasses within the glass, allowing smaller entrained gas bubbles that do not escape the molten glass fining bath to dissolve back into the glass.

Molten glass bath flows from the fining chamber of the furnace into the forehearth. The forehearth defines an elongated channel having a series of gradually decreasing temperature zones and may additionally include an alcove that fluidly connects the elongated channel to the fining chamber of the furnace. As the molten glass flows through the elongated channel, the glass is cooled at a controllable rate to raise its viscosity to a level more conducive to glass forming operations. When forming glass containers, for example, thermally conditioned molten glass may be collected in a feeder spout of the forehearth, which is located at an output end of the elongated channel. The feeder spout typically includes at least one reciprocally moveable plunger that controls the discharge of a stream or runner of molten glass through at least one corresponding orifice defined in an orifice plate of the spout. Gobs of conditioned molten glass are sheared from the glass stream and are distributed individually to a blank mold via a gob distribution system. The glass gob is then formed into a parison within the blank mold. After the parison is formed, the parison is transferred to a blow mold where it is blown into a glass container. The glass container is then typically annealed and coated with one or more surface coatings.

As explained above, gas bubbles that remain in the glass are generally considered to be defects as they introduce noticeable visual imperfections in the formed glass articles. Entrained gas bubbles typically fall into one of two categories: blisters or seeds. Blisters refer to gas bubbles that have a diameter of greater than 0.8 mm, while seeds refer to gas bubbles that have a diameter of 0.8 mm or less. In the event that some amount of seeds are desired to be retained in the final glass for surface decoration, glass stylistic detail, or some other reason, conventional glass processing practices would dictate that the vitrifiable feed material be adjusted to help stabilize the presence of seeds in the molten glass, such as by removing chemical fining agents from the feed material. This conventional practice, however, would result in operational inefficiency as commercially viable glass may not be produced while the glass composition is transitioning between different vitrifiable feed material recipes, and it would also prolong the exposure of furnace refractory materials to molten glass containing a relatively large amount of entrained gas bubbles, which is known to accelerate corrosion and degradation of the refractory materials at melting and fining chamber temperatures. The present disclosure provides a more efficient, economical, and strategic approach to producing “seedy” molten glass that does not necessarily require adjustments to the vitrifiable feed material recipe.

### SUMMARY OF THE DISCLOSURE

The present disclosure relates to a method for producing conditioned molten glass and controlling the concentration of seeds within the conditioned molten glass. Specifically, to introduce seeds into, and thus increase the concentration of seeds within an outflow of conditioned molten glass that is discharged from a forehearth of a glass-making furnace, typically through an orifice of a glass feeder, a particulate mixture that comprises (i) silicon carbide (SiC) particles and (ii) carrier particles comprised of glass particles and/or vitrifiable particles is introduced into at least one of the molten glass fining bath contained in the fining chamber of the furnace or a flow of molten glass contained in the forehearth. The SiC particles create seeds that persist within the conditioned molten glass that is discharged from the forehearth and, thus, articles that contain a greater concentration of seeds than would otherwise be present can be formed from the conditioned molten glass. The carrier particles serve to disperse the SiC particles within the molten glass to ensure the SiC particles do not conglomerate to produce irregular distributions of seeds with inconsistent gas bubble sizes. The same glass-making furnace may also be used to form glass articles having a lower concentration of seeds by withholding the introduction of the particulate mixture into the fining chamber and/or the forehearth.

The present disclosure embodies a number of aspects that can be implemented separately from or in combination with each other to provide a method for producing glass. According to one embodiment of the present disclosure, a method of forming glass articles may include several steps. One step of the method involves providing a glass-making furnace that comprises a melting chamber, a fining chamber, and a forehearth. The melting chamber and the fining chamber are separated by a throat, and the forehearth is fluidly coupled to the fining chamber. The melting chamber contains a molten glass bath into which a vitrifiable feed material is introduced while the fining chamber contains a molten glass fining bath that receives glass from the molten glass bath in the melting chamber through the throat. Furthermore, the forehearth includes an elongated channel along which a flow of molten glass pulled from the molten glass fining bath travels. Another step of the method involves introducing a particulate mixture that comprises SiC particles and carrier particles into at least one of the molten glass fining bath or the flow of molten glass that within the forehearth to create seeds within, and to thereby increase a concentration of seeds within, the flow of molten glass within the forehearth. Yet another step of the method involves discharging an outflow of conditioned molten glass from the forehearth. And still another step of the method involves forming a glass article from the outflow of conditioned molten glass.

According to another aspect of the present disclosure, a method of forming glass articles may include several steps. One step of the method involves (a) delivering a flow of molten glass into an elongated channel of a forehearth along which the flow of molten glass is cooled. Another step of the method involves (b) discharging an outflow of conditioned molten glass from the forehearth as a first set of gobs of molten glass. The outflow of conditioned molten glass has a first concentration of seeds. Yet another step of the method involves (c) forming a glass article from one of the gobs of the first set of gobs of molten glass. Still another step of the method involves (d) introducing a particulate mixture that comprises SiC particles and carrier particles into at least one of the flow of molten glass that is flowing through the forehearth or a molten glass fining bath from which the flow of molten glass within the forehearth is pulled. The particulate mixture increases a concentration of seeds within the outflow of conditioned molten glass from the first concentration of seeds to a second concentration of seeds. The carrier particles included in the particulate mixture comprise at least one of cullet particles, glass frit particles, or vitrifiable particles. Another step of the method involves (e) discharging the outflow of conditioned molten glass from the forehearth as a second set of individual gobs of molten glass after introducing the particulate mixture in step (d). And still another step of the method involves (f) forming a glass article from one of the gobs of the second set of individual gobs of molten glass.

### BRIEF DESCRIPTION OF THE DRAWINGS

The disclosure, together with additional objects, features, advantages, and aspects thereof, will be best understood from the following description, the appended claims, and the accompanying drawings, in which:

FIG. 1 is a cross-sectional view of a glass-making furnace according to one embodiment of the present disclosure;

FIG. 2 is a magnified view of the forehearth of the glass-making furnace depicted in FIG. 1 according to one embodiment of the present disclosure;

FIG. 3 is a flow chart that depicts a general method for forming glass containers from an outflow of conditioned molten glass discharged from the forehearth of the glass-making furnace depicted in FIG. 1 according to one embodiment of the present disclosure; and

FIG. 4 is a side elevational view of a representative glass container that may be formed from the outflow of conditioned molten glass discharged from the forehearth of the glass-making furnace depicted in FIG. 1 according to one embodiment of the present disclosure.

### DETAILED DESCRIPTION

A method of forming glass articles and, in particular, glass containers-having varying concentrations of seeds without necessarily requiring adjustments to the composition of the vitrifiable feed material fed to the furnace is disclosed. The concentration of seeds contained within the glass of the glass containers may, in some instances, be categorized as “seedy” or “non-seedy” for expediency. While the distinction between “seedy” and “non-seedy” glass can vary depending on consumer demands, in certain embodiments glass and the articles formed therefrom are considered “seedy” if the glass has a seed concentration of 1-100 seeds per gram of glass or, more narrowly, from 4 seeds per gram of glass to 10 seeds per gram of glass. In one embodiment, glass may be considered “seedy” if it exhibits a seed concentration that ranges from 5.5 seeds per gram of glass to 7.5 seeds per gram of glass. Conversely, in certain embodiments, glass and the articles formed therefrom are considered “non-seedy” if the glass has a seed concentration of less than 1 seed per gram of glass or, more narrowly, a seed concentration that ranges from zero seeds per gram of glass to 0.5 seeds per gram of glass. Seedy glass may be desired for a variety of glass articles including glass containers manufactured for the spirt industry in which an aesthetic visual appearance of the glass containers attributed to seedy glass may be exploited to build or support brand identity or to provide a different aesthetic to the consuming public.

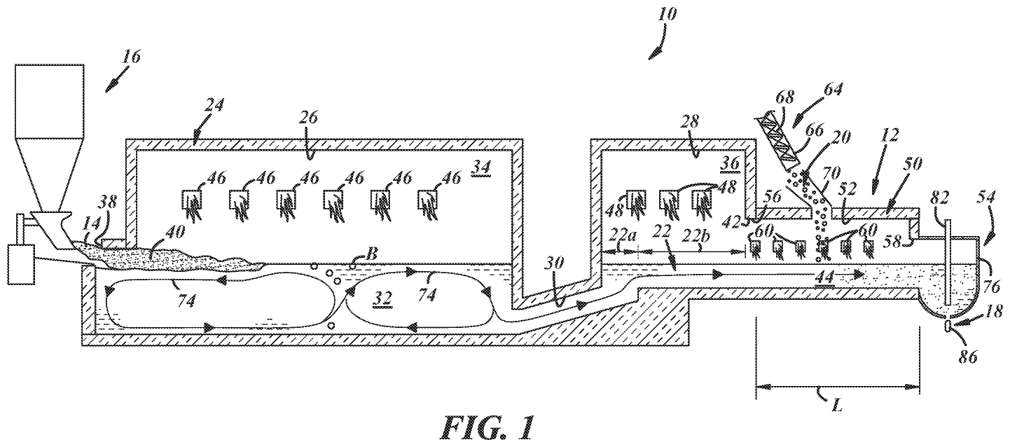

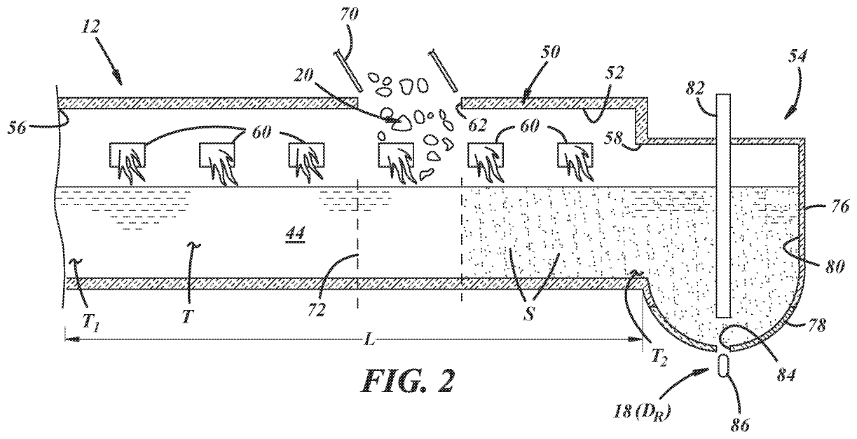

The presently-disclosed glass article forming method is practiced using a glass manufacturing system that includes a continuous glass-making furnace 10. The furnace 10 includes at least one forehearth 12 as shown, for example, in FIGS. 1-2. The furnace 10 receives an input of a vitrifiable feed material 14 from a batch feeder 16 and discharges, from the forehearth 12, an outflow of temperature-conditioned molten glass 18. The outflow of conditioned molten glass 18 may be formed into glass articles such as glass containers. A particulate mixture 20 that includes (i) SiC particles and (ii) carrier particles comprised of glass particles and/or vitrifiable particles may be introduced into molten glass within the furnace 10 either in the forehearth 12 or upstream of the forehearth 12 in a molten glass fining bath 22 contained within the furnace 10. The particulate mixture 20 creates seeds that persist within the outflow of conditioned molten glass 18 and therefore increase the seed content of the outflow of conditioned molten glass 18. In this way, both seedy and non-seedy glass articles including, for example, glass containers, can be formed from the outflow of conditioned molten glass 18 by commencing or withholding the addition of the particulate mixture 20. Recipe changes to the vitrifiable feed material 14 are not necessarily required.

The furnace 10 includes a housing 24 constructed from refractory materials that defines a melting chamber 26, a fining chamber 28, and a throat 30 that separates the melting and fining chambers 26, 28. Molten glass partially fills the melting and fining chambers 26, 28, and fully fills the throat 30. A molten glass bath 32 is contained within the melting chamber 26 and it is this bath 32 into which the vitrifiable feed material 14 is introduced. The molten glass fining bath 22 is contained within the fining chamber 28 and receives with molten glass from the melting chamber 26 through the throat 30, which is submerged below the levels of the molten glass bath 32 and the fining glass bath 22 and allows glass to flow from the upstream melting chamber 26 to the downstream fining chamber 28. As the molten glass bath 32 and the molten glass fining bath 22 only partially fill their respective chambers 26, 28, a melting chamber combustion zone 34 is present within the melting chamber 26 above the molten glass bath 32 contained therein and an fining chamber combustion zone 36 is present within the fining chamber 28 above the molten glass fining bath 22. A relatively large quantity of the molten glass-typically 30 tons to 1000 tons—is contained in the furnace 10 to support a glass residence time within the melting and fining chambers 26, 28 that ranges from 8 hours to 72 hours. The molten glass that comprises the molten glass bath 32 and the molten glass fining bath may be soda-lime-silica glass.

A batch inlet 38 is defined in the housing 24 and provides an entrance to the melting chamber 26 for the delivery of the vitrifiable feed material 14 onto the molten glass bath 32. The vitrifiable feed material 14 is distributed over a section of the molten glass bath 32 as a batch blanket 40 that melts and reacts to form glass that mixes into the molten glass bath 32 over time. A glass outlet 42 is also defined in the housing 24 and provides an exit from the fining chamber 28 through which a flow of molten glass 44 is pulled from the molten glass fining bath 22 to supply the forehearth 12. As shown best in FIG. 1, the molten glass fining bath 22 includes an upward flowing portion 22a and a horizontally flowing portion 22b. The upward flowing portion 22a runs from the throat 30 upwards to the horizontally flowing portion 22b, which flows perpendicular to gravity, and the horizontally flowing portion 22b flows toward and exits the fining chamber 28 through the glass outlet 42. The term “perpendicular to gravity” includes up to 5° of slope from true perpendicular.

A plurality of overhead burners 46 is mounted in the housing 24 within the melting chamber 26. Each of these overhead burners 46 combusts a combustible mixture, which comprises an oxidant and a fuel, and discharges a resultant combustion flame into the melting chamber combustion zone 34 above the molten glass bath 32. These combustion flames heat the molten glass bath 32 to facilitate melting and reacting of the vitrifiable feed material 14. During operation of the furnace 10, and when the molten glass bath 32 is comprised of soda-lime-silica glass, the molten glass bath 32 may be maintained within a temperature range of 1200° C. to 1550° C. Similarly, a plurality of overhead burners 48 may be mounted in the housing 24 within the fining chamber 28. Each of these overhead burners 48 also combusts a combustible mixture and discharges a resultant combustion flame into the refining chamber combustion zone 36 above the molten glass fining bath 22. These combustion flames allow the molten glass fining bath 22 to cool at a controlled rate to help facilitate the ascension and removal of entrained gas bubbles from the molten glass fining bath 22. During operation of the furnace 10, and when the molten glass fining bath 22 is comprised of soda-lime-silica glass, the molten glass fining bath 22 contained within the fining chamber 28 may be maintained within a temperature range of 1450° C. to 1150° C.

The forehearth 12 is fluidly connected to the fining chamber 28. The forehearth 12 receives the flow of molten glass 44 from the fining chamber 28 and discharges the outflow of conditioned molten glass 18 at a discharge flow rate DR. The forehearth 12 has a housing 50 that defines an elongated channel 52, along which the flow of molten glass 44 is cooled, and further includes a glass feeder 54 that delivers the outflow of conditioned molten glass 18. The forehearth 12 may additionally include, but does not have to include, an alcove (not shown) that fluidly connects the elongated channel 52 to the fining chamber 28 of the furnace 10 to deliver the flow of molten glass 44 to the elongated channel 52. The housing 50 further defines an inlet 56 to and an outlet 58 from the elongated channel 52 that are spaced apart along a length L of the elongated channel 52. The flow of molten glass 44 flows from the inlet 56 to the outlet 58 of the elongated channel 52 and ultimately enters the glass feeder 54. The outflow of conditioned molten glass 18 is discharged from the forehearth 12 as individual gobs of molten glass through the glass feeder 54, as will be further explained below.

A plurality of overhead burners 60 is mounted within the elongated channel 52 of the forehearth 12. Each of these burners 60 combusts a combustible gas mixture and discharges a combustion flame into the elongated channel 52 above the flow of molten glass 44. The overhead burners 60 are operated to condition the flow of molten glass 44; that is, as shown best in FIG. 2, to gradually reduce a temperature T of the flow of molten glass 44 along the length L of the elongated channel 52 from a first temperature T₁ at the inlet 56 of the channel 52 to a second temperature T₂ at the outlet 58 of the channel 52 to homogenize the temperature of the glass and achieve a glass viscosity appropriate for downstream glass forming operations. As applicable to glass-container forming operations, for example, in which the molten glass is soda-lime-silica glass, the first temperature T₁ of the flow of molten glass 44 may range from 1100° C. to 1450° C. and the second temperature T₂ of the flow of molten glass 44 may range from 1050° C. to 1250° C. The flow of molten glass 44 is more thermally homogenized at the second temperature T₂ and, as a result of being at the second temperature T₂, has a glass viscosity of between 101.5 Pa·s and 103 Pa·s.

An auxiliary inlet 62 may additionally be defined in the housing 50 of the forehearth 12 between the inlet 56 and the outlet 58 to permit the selective introduction, at a controlled feed rate, of the particulate mixture 20 into the flow of molten glass 44 should the mixture 20 be introduced at that location of the forehearth 12. The auxiliary inlet 62 may be a single opening that provides access to the elongated channel 52 or it may collectively be several such openings. The auxiliary inlet 62 receives the particulate mixture 20 from an auxiliary feeder 64 that can meter solid particulate material. For example, the auxiliary feeder 64 may be an extruder that comprises a feed tube 66 and a rotating screw 68 located within and surrounded by the feed tube 66. The rotating screw 68 rotates within the feed tube 66 to move a quantity of the particulate mixture 20 axially through the feed tube 66 at a controlled feed rate. The quantity of the particulate mixture 20 that exits the feed tube 66 may be delivered to a guide 70, which is arranged in feeding communication with the auxiliary inlet 62 to introduce the particulate mixture 20 into the flow of molten glass 44.

The SiC particles and the carrier particles function synergistically when added to molten glass—e.g., the molten glass fining bath 22 or the flow of molten glass 44—to create seeds S (FIG. 2) within the glass. The SiC particles may contain at least 90 wt % SiC, or in some instances at least 98 wt % SiC, with the remainder being one or more of SiO₂, C, Si, Fe, and Al, plus acceptable impurities. Such SiC particles may be acquired commercially from Rosber SA de CV (headquartered in Naucalpan de Juárez, Mexico). The carrier particles include glass particles and/or vitrifiable particles. The glass particles may be cullet particles, frit, or any other vitreous glass, and contain at least 50 wt % SiO₂. In one embodiment, the glass particles may be soda-lime-silica glass particles, preferably if the flow of molten glass 44 is soda-lime-silica glass as well. The vitrifiable particles are particles that are not considered glass but can be melted into a vitreous state. For example, the vitrifiable particles may be granules of oxides, carbonates, or other glass-precursor materials that, when introduced into the flow of molten glass 44, melt to form glass that contains at least 50 wt % SiO₂, including glass that has a soda-lime-silica glass composition if desired.

The SiC particles react, typically with oxygen, and then melt within the molten glass in which they are added to release CO₂ gas, CO gas, or both CO₂ gas and CO gas. The released gas(es) become entrained within the glass matrix to form the included seeds S. To help ensure that the SiC particles are well dispersed—as opposed to forming clusters-so that the resultant seeds S are well distributed within the glass, the SiC particles are mixed with the carrier particles within the particulate mixture 20. The properties of the particulate mixture 20 can affect the nature of the seeds S produced, which are carried forward and maintained within the outflow of conditioned molten glass 18 and the glass articles formed therefrom, as well as the tendency of the flow of molten glass 44 to foam.

The inclusion of SiC particles in the particulate mixture 20 generally has the effect of increasing the size and the amount of produced seeds S. To that end, the inclusion of too great an amount of SiC particles in the particulate mixture 20 can cause the molten glass to foam as a result of forming a greater quantity of larger seeds. And the presence of foam in the flow of molten glass 44 is generally sought to be avoided as foam can translate into perceptible streaks within glass articles formed from the glass. Additionally, the temperature of the molten glass is inversely proportional to the size of the seeds S created; that is, larger seeds are produced at lower glass temperatures and smaller seeds are produced at higher glass temperatures Consequently, any or all of the following factors may be considered for their individual or collective contribution to seed formation: (1) the size of the SiC particles and the carrier particles; (2) the ratio of the SiC particles to the carrier particles by weight (SiC:carrier weight ratio) within the particulate mixture 20; (3) the amount of the particulate mixture 20 added into the molten glass fining bath 22 and/or the flow of molten glass 44; and (4) the location at which the particulate mixture 20 is introduced into the flow of molten glass 44.

While any one or more of the four factors recited above may be varied to tailor the size and/or concentration of the created seeds S, applicable ranges for each have been determined for the production of seedy glass. For instance, the particle size of the SiC may range from 10 μm to 120 μm, or more narrowly from 30 μm to 80 μm, and the particle size of the carrier particles may range from 50 μm to 300 μm, or more narrowly from 100 μm to 200 μm. The “particle size” as used here refers to the measured length of the largest dimension of the particle. The SiC particles and the carrier particles may also be included in the particulate mixture 20 in a SiC:carrier weight ratio that ranges from 1:1000 to 1:2.5 or, more narrowly, from 1:1000 to 1:100 or from 1:500 to 1:100 or even from 1:500 to 1:250. The particulate mixture 20 may be introduced into the molten glass fining bath 22, the flow of molten glass 44 within the elongated channel 52 of the forehearth 12, or both, to provide a flow rate of the combined weight of the SiC particles and the carrier particles (at the SiC:carrier weight ratio) that ranges from 0.1% to 5.0%, or more narrowly from 0.4% to 0.85%, or even more narrowly from 0.5% to 0.75%, of the discharge flow rate DR of the outflow of conditioned molten glass 18. Moreover, if the some or all of the particular mixture 20 is introduced into the flow of molten glass 44, the particulate mixture 20 may be added to the flow of molten glass 44 in a zone 72 of the forehearth 12 in which the temperature T of the flow of molten glass 44 ranges from 1100° C. to 1400° C. or, more narrowly, from 1275° C. to 1375° C.

The concentration of seeds S in the outflow of conditioned molten glass 18 exiting the forehearth 12 can be selectively varied by simply commencing the introduction of the particulate mixture 20 into the molten glass fining bath 22 and/or the flow of molten glass 44 contained in the forehearth. By commencing the introduction of the particulate mixture 20, the concentration of seeds S within the outflow of conditioned molten glass 18 can be increased relatively quickly without necessarily having to rely on adjustments to the recipe of the vitrifiable feed material 14. This transition can occur quickly since it does not require a recipe change in the vitrifiable feed material 14, which is generally slow to produce the intended effect in the conditioned molten glass 18 and, as such, may result in a large amount of transitionary glass that has no commercial value. The same glass-making furnace 10 can thus produce glass with significantly different seed contents, and can transition between the two based on the demand for each type of glass and production scheduling logistics. And since the concentration of seeds S of the glass is adjusted within the forehearth 12 or the fining chamber 28, the melting chamber 26, which tends to run hotter than the fining chamber 28 and the forehearth 12, is spared from the more aggressive corrosion mechanisms associated with overly bubbly glass.

During operation of the glass-making furnace 10, the vitrifiable feed material 14 is introduced into the melting chamber 26 and is distributed over a section of the molten glass bath 32 as the batch blanket 40. The vitrifiable feed material 14 melts, flows, and mixes into the molten glass bath 32 as assisted by convective flow currents 74 that are present within the molten glass bath 32 and the radiant heat provided by the overhead burners 46 within the melting chamber 26. The reaction or decomposition of the various ingredients of the vitrifiable feed material 14 within the molten glass bath 32 produces gas bubbles B. The vitrifiable feed material 14 may be formulated to produce any type of glass, including various oxide glasses, with a specified glass chemistry. For example, the vitrifiable feed material 14 may be formulated to produce soda-lime-silica glass, which has a glass chemical composition that includes 60 wt % to 80 wt % SiO₂, 8 wt % to 18 wt % Na₂O, and 5 wt % to 15 wt % CaO, based on the total weight of the glass. In addition to SiO₂, Na₂O, and CaO, the glass chemical composition of soda-lime-silica glass may include other oxide and non-oxide materials including aluminum oxide (Al₂O₃), magnesium oxide (MgO), potassium oxide (K₂O), carbon, sulfates, nitrates, fluorines, chlorines, and/or elemental or oxide forms of one or more of iron, arsenic, antimony, selenium, chromium, barium, manganese, cobalt, nickel, sulfur, vanadium, titanium, lead, copper, niobium, molybdenum, lithium, silver, strontium, cadmium, indium, tin, gold, cerium, prascodymium, neodymium, curopium, gadolinium, erbium, and uranium. Regardless of what other oxide and/or non-oxide materials are present in the soda-lime-glass besides SiO₂, Na₂O, and CaO, the sum total of those additional materials is preferably 10 wt % or less, or more narrowly 5 wt % or less, based on the total weight of the soda-lime-silica glass.

The molten glass bath 32 flows from the melting chamber 26 to the fining chamber 28 through the submerged throat 30. Most of the originally-formed gas bubbles B are removed along the way. The fining process begins in the melting chamber 26 as the larger of the entrained gas bubbles B quickly ascend up through the molten glass bath 32 while, in the fining chamber 28, the smaller of the entrained gas bubbles B either ascend up through molten glass fining bath 22 or are reabsorbed by the glass. The flow of molten glass 44 is pulled into the forehearth 12 from the fining chamber 28 and is received into the elongated channel 52 through the inlet 56. The flow of molten glass 44 flows through the elongated channel 52 to the outlet 58 and along that path is reduced in temperature from its first temperature T₁ at the inlet 56 to its second temperature T₂ at the outlet 58. The flow of molten glass 54 thus becomes more thermally conditioned, its temperature is reduced, and its viscosity is increased as it moves through the elongated channel 52 of the forehearth 12.

At an exit of the forehearth 12, the outflow of conditioned molten glass 18 is discharged from of the forehearth 12 at the specified discharge flow rate DR. The outflow of conditioned molten glass 18 may be supplied to glass article forming equipment. In the context of commercial glass container manufacturing, for example, the elongated channel 52 is in flow communication with the glass feeder 54, which discharges the outflow of conditioned molten glass 18 as individual gobs of molten glass. As shown in FIGS. 1-2, the glass feeder 54 includes a spout bowl 76 and a bottom orifice plate 78 that together define a spout chamber 80. The glass feeder 54 also includes at least one plunger 82 that, typically, reciprocates relative to the orifice plate 78 and controls the flow of conditioned molten glass held within the spout chamber 80 through an aligned orifice 84 in the orifice plate 78 to fashion a stream of molten glass. Each of the streams of conditioned molten glass may be cut by shearing blades (not shown) into a gob of molten glass 86 that can be individually formed into a glass container upon delivery to glass container forming machine.

The particulate mixture 20 can be used, when desired, to adjust the concentration of seeds S in the output of conditioned molten glass 18. By withholding the addition of the particulate mixture 20, seeds S are not created and the concentration of seeds S in the flow of molten glass 44 within the forehearth 12 is not increased. As such, the output of conditioned molten glass 18 discharged from the forehearth 12 has a first concentration of seeds S that results from the melting and fining operations taking place in the melting and fining chambers 26, 28 of the furnace 10. The first concentration of seeds S may be less than 1 seed per gram of glass or, more narrowly, may be 0-0.5 seeds per gram of glass. Glass articles that also include seeds S at the first concentration may then be formed from the outflow of conditioned molten glass 18, which is discharged from the glass feeder 54 as a first set of gobs of molten glass. Specifically, a single glass container is formed from one of the gobs of the first set of gobs of molten glass in a glass container forming machine, and several different forming machines may be operational at the same time to repeatedly form gobs from the first set of gobs of molten glass into many glass containers. A brief description of how a molten glass gob is formed into a glass container can be found below.

When, however, conditioned molten glass with a greater seed concentration is desired, the particulate mixture 20 is introduced into the molten glass fining bath 22, preferably the horizontally flowing portion 22b, or the flow of molten glass 44 contained within the forehearth 12, preferably within the elongated channel 52. Of course, the particulate mixture 20 could be introduced into the conditioned molten glass within the spout chamber 80 of the glass feeder 54 or the alcove of the forehearth 12 if desired. The particulate mixture 20 may be added in accordance with one or more of the factors discussed above (i.e., SiC and carrier particle sizes, the SiC:carrier weight ratio, the amount of SiC particles and carrier particles introduced, and the location at which the particulate mixture 20 is added).

The particulate mixture 20 causes the concentration of seeds S in the outflow of conditioned molten glass 18 discharged from the forehearth 12 to increase from the first concentration of seeds S to a second concentration of seeds S that is greater than the first concentration of seeds S. The second concentration of seeds S may range from 1-100 seeds per gram of glass and, additionally, to have the intended visual effect in the glass, the average diameter of the seeds S may be controlled using one or more of the four factors listed above to be between 0.05 mm and 0.25 mm or, more preferably, between 0.1 mm and 0.2 mm. Glass articles that also include seeds S at the second concentration may then be formed from the outflow of conditioned molten glass 18, which is discharged from the glass feeder 54 as a second set of gobs of molten glass. Specifically, a single glass container is formed from one of the gobs of the second set of gobs of molten glass in a glass container forming machine, as before, and several different forming machines may be operational at the same time to repeatedly form gobs from the second set of gobs of molten glass into many glass containers.

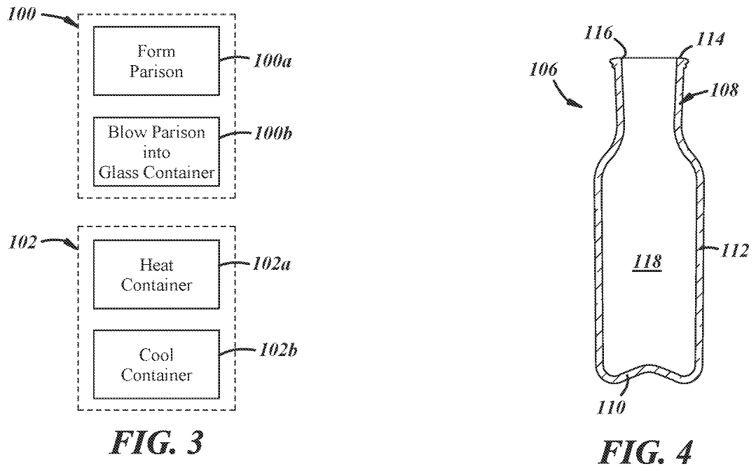

Glass containers may be formed from the conditioned molten glass 18 (whether it includes seeds S at the first or second concentration) obtained from the forehearth 12 in a forming step 100 as shown in the flow diagram of FIG. 3. In standard container-forming processes, the outflow of conditioned molten glass 18 is discharged as the individual gobs of molten glass 86 from the glass feeder 54. Each gob 86 is delivered into a blank mold of a glass container forming machine. Once in the blank mold, the molten glass gob 86 is pressed or blown in substep 100a into a parison or preform that includes a tubular wall. The parison is then transferred from the blank mold into a blow mold of the glass container forming machine. Once the parison is received in the blow mold, the blow mold is closed and the parison is rapidly outwardly blown in substep 100b into the glass container having a shape that matches the contour of the mold cavity using a compressed gas such as compressed air. Other approaches may of course be implemented to form the glass containers besides the press-and-blow and blow-and-blow forming techniques including, for instance, compression or other molding techniques.

The glass container formed within the blow mold is shown generally in FIG. 4 and is denoted by reference numeral 106. The glass container 106 has a hollow glass substrate 108 that includes a closed base 110 and a peripheral wall 112. The peripheral wall 112 extends from the closed base 110 and terminates in a mouth 114 that defines an opening 116 to a containment space 118 defined by the closed base 110 and the peripheral wall 112. Once formed, the glass container 106 is removed from the blow mold and placed on a conveyor or other transport device. The glass container 106 is then annealed in an annealing lehr to relax thermally-induced strain and remove internal stress points in step 102. The annealing of the glass container 106 involves heating the glass container 106 in substep 102a to a temperature above the annealing point of the glass, which for soda-lime-silica glass usually lies within the range of 510° C. to 550° C., followed by slowly cooling the container 106 in substep 102b at a rate of 1° C./min to 10° C./min to a temperature below the strain point of the glass, which for soda-lime-silica glass usually lies within the range of 470° C. to 500° C. Moreover, any of a variety of coatings may be applied to the surface of the glass container 106 either before (hot-end coating(s)) or after (cold-end coating(s)) annealing.

The hollow glass substrate 108 that defines the shape of the glass container 106 includes seeds distributed throughout the substrate 108 at the second concentration when the particulate mixture 20 is added to the furnace 10 as described above and the glass container 106 is formed from the one of the gobs of the second set of individual gobs of molten glass. A distribution of internal seeds at the second concentration can present a visually appealing and aesthetic appearance to the glass container 106. But not all glass containers are desired to have such a high concentration of seeds S and, in fact, the demand for glass containers with much less included seeds S is almost assuredly to be higher than, if not significantly higher than, the demand for glass containers in which seeds S are deliberately added to the glass. In that regard, to transition the output of conditioned molten glass 18 to a lower acceptable seed concentration, the particulate mixture 20 is not introduced into the furnace 10 as described above, and the glass container 106 is formed from one of the gobs of the first set of individual gobs of molten glass.

There thus has been disclosed a glass-making furnace and a method of producing conditioned molten glass that satisfies one or more of the objects and aims previously set forth. The disclosure has been presented in conjunction with several illustrative embodiments, and additional modifications and variations have been discussed. Other modifications and variations readily will suggest themselves to persons of ordinary skill in the art in view of the foregoing discussion. For example, the subject matter of each of the embodiments is hereby incorporated by reference into each of the other embodiments, for expedience. The disclosure is intended to embrace all such modifications and variations as fall within the spirit and broad scope of the appended claims.

1. A method of forming glass articles, the method comprising:
providing a glass-making furnace that comprises a melting chamber, a fining chamber, and a forehearth, the melting chamber and the fining chamber being separated by a throat, and the forehearth being fluidly coupled to the fining chamber, and wherein the melting chamber contains a molten glass bath into which a vitrifiable feed material is introduced, the fining chamber contains a molten glass fining bath that receives glass from the molten glass bath in the melting chamber through the throat, and the forehearth that includes an elongated channel along which a flow of molten glass pulled from the molten glass fining bath travels;
introducing a particulate mixture that comprises SiC particles and carrier particles into at least one of the molten glass fining bath or the flow of molten glass within the forehearth to create seeds within, and to thereby increase a concentration of seeds within, the flow of molten glass within the forehearth;
discharging an outflow of conditioned molten glass from the forehearth; and
forming a glass article from the outflow of conditioned molten glass.

2. The method set forth in claim 1, wherein the carrier particles included in the particulate mixture comprise cullet particles.

3. The method set forth in claim 1, wherein the carrier particles included in the particulate mixture comprise glass frit.

4. The method set forth in claim 1, wherein the carrier particles included in the particulate mixture comprise vitrifiable particles that melt into a vitreous state when introduced into the flow of molten glass.

5. The method set forth in claim 1, wherein the SiC particles in the particulate mixture have particle sizes that range from 10 μm to 120 μm, and wherein the carrier particles in the particulate mixture have particle sizes that range from 50 μm to 300 μm.

6. The method set forth in claim 5, wherein the SiC particles in the particulate mixture have particle sizes that range from 30 μm to 80 μm, and wherein the carrier particles in the particulate mixture have particle sizes that range from 100 μm to 200 μm.

7. The method set forth in claim 1, wherein a weight ratio of the SiC particles to the carrier particles in the particulate mixture ranges from 1:1000 to 1:2.5.

8. The method set forth in claim 7, wherein the weight ratio of the SiC particles to the carrier particles in the particulate mixture ranges from 1:500 to 1:100.

9. The method set forth in claim 7, wherein the weight ratio of the SiC particles to the carrier particles in the particulate mixture ranges from 1:500 to 1:250.

10. The method set forth in claim 1, wherein a flow rate of a combined weight of the SiC particles and the carrier particles in the particulate mixture into at least one of the molten glass fining bath or the flow of molten glass within the forehearth ranges from 0.1% to 5.0% of a discharge flow rate of the outflow of conditioned molten glass from the forehearth.

11. The method set forth in claim 10, wherein the flow rate of the combined weight of the SiC particles and the carrier particles ranges from 0.5% to 0.75% of the discharge flow rate of the outflow of conditioned molten glass from the forehearth.

12. The method set forth in claim 1, wherein the particulate mixture is introduced into the flow of molten glass within in a zone of the forehearth in which a temperature of the flow of molten glass ranges from 1100° C. to 1400° C.

13. The method set forth in claim 1, wherein the SiC particles and the carrier particles in the particulate mixture have particle sizes that range from 10 μm to 120 μm and from 50 μm to 300 μm, respectively, wherein a weight ratio of the SiC particles to the carrier particles in the particulate mixture ranges from 1:1000 to 1:2.5, wherein the particulate mixture is introduced into the flow of molten glass within in a zone of the forehearth in which a temperature of the flow of molten glass ranges from 1100° C. to 1400° C., and wherein a flow rate of a combined weight of the SiC particles and the carrier particles in the particulate mixture into the flow of molten glass within the forehearth ranges from 0.1% to 5.0% of a discharge flow rate of the outflow of conditioned molten glass from the forehearth.

14. The method set forth in claim 1, wherein the outflow of conditioned molten glass has a soda-lime-silica glass chemical composition.

15. The method set forth in claim 1, wherein forming the glass article from the outflow of conditioned molten glass comprises forming a glass container that includes a hollow glass substrate.

16. A method of forming glass articles, the method comprising:
(a) delivering a flow of molten glass into an elongated channel of a forehearth along which the flow of molten glass is cooled;
(b) discharging an outflow of conditioned molten glass from the forehearth as a first set of gobs of molten glass, the outflow of conditioned molten glass having a first concentration of seeds;
(c) forming a glass article from one of the gobs of the first set of gobs of molten glass;
(d) introducing a particulate mixture that comprises SiC particles and carrier particles into at least one of the flow of molten glass that is flowing through the forehearth or a molten glass fining bath from which the flow of molten glass within the forehearth is pulled, the particulate mixture increasing a concentration of seeds within the outflow of conditioned molten glass from the first concentration of seeds to a second concentration of seeds, wherein the carrier particles comprise at least one of cullet particles, glass frit particles, or vitrifiable particles;
(e) discharging the outflow of conditioned molten glass from the forehearth as a second set of second individual gobs of molten glass after introducing the particulate mixture in step (d); and
(f) forming a glass article from one of the gobs of the second set of individual gobs of molten glass.

17. The method set forth in claim 16, wherein the outflow of conditioned molten glass has a soda-lime-silica glass chemical composition.

18. The method set forth in claim 16, wherein each of the glass article formed in step (c) and the glass article formed in step (f) is a glass container that includes a hollow glass substrate having an closed base and a peripheral wall that extends from the closed base to a mouth.

19. The method set forth in claim 16, wherein the glass article formed in step (f) has a seed concentration that ranges from 4 seeds per gram of glass to 10 seeds per gram of glass.
